(19) United States
(12) Patent Application Publication
(10) Pub. No.: US 2002/0181058 A1
(43) Pub. Date: Dec. 5, 2002

(54) System and method for establishing multiple optical links between transceiver arrays

(76) Inventors: Gary Ger, Mt. Laurel, NJ (US); Keith W. Goossen, Howell, NJ (US); Ashok Krishnamoorthy, Lawrenceville, NJ (US)

Correspondence Address: DEMONT & BREYER, LLC, PO BOX 7490, SHREWSBURY, NJ, 07702, US

(21) Appl. No.: 09/872,571

(22) Filed: Jun. 1, 2001

(51) Int. Cl. H04B 10/00

(52) U.S. Cl. 359/163; 359/152

(57) ABSTRACT

A multiple channel transmission system includes at least two plug in modules interconnected by a plurality of optical fiber bundles. For greater transceiver density and design flexibility, two-dimensional transceiver arrays (e.g., N×M arrays of transmitters and/or receivers) are mounted on a major surface of each plug-in module. Optical fiber connectors are employed at a peripheral edge of each plug-in module, and optical fibers interconnecting the transceivers and corresponding edge mounted connectors are bundled into two dimensional (N×M) arrays at the point where they are optically coupled to two dimensional transceiver arrays (e.g., N×M arrays of transmitters and/or receivers). The bundle groups exiting each transmitter array fan out or diverge as they approach a corresponding group of edge mounted fiber connectors. Optical interconnections between plug-in modules are achieved by fiber connections between edge mounted connectors.

### BACKGROUND OF THE INVENTION

1. Field of the Invention

The present invention relates generally to the exchange of data between optoelectronic circuit modules and, more particularly, to an arrangement of transmitters and receivers and associated optical fibers for efficient data transfer wherein the fibers are bundled and routed for a specific application.

2. Discussion of the Background Art

Technological advancements have dramatically increased the capabilities and possibilities of communication circuits and systems. The increased bandwidth and data transfer rates have resulted in commercial innovation and scientific advancements in many fields. However, data transfer continues to be a bottleneck. This is true for data transfer within an integrated circuit (IC), from one chip to another, from hybrid circuit to hybrid circuit, from integrated circuit board to another integrated circuit board, and from system to system.

In general, the problems associated with data transfer within an IC and between circuit modules of a system network are similar. With respect to IC's, increasing the rate of data transfer can be accomplished by increasing the number of data transfer lines and transferring the data in parallel, and/or increasing the transmission speed. There are limitations, however, to the number of I/O lines such as spacing and size requirements, noise problems, reliability of connectors, and the power required to drive multiple lines off-chip. Increasing the transmission speed also has some limitations, as increasing the speed also increases power requirements, introduces timing skew problems across a channel, and usually requires more exotic processing than is standard practice.

Combining higher clock speeds and more I/O connections in order to increase bandwidth is exceedingly difficult using electronics alone. The maximum clock rate of an I/O pin, for example, is typically a few hundred Mbps (millions of bits per second) due to capacitance and inductance and crosstalk associated with the connections between die and package. Accordingly, the maximum I/O bandwidth of a single IC package is directly proportional to the number of pins times the clock rate per pin. In general, the maximum I/O bandwidth of a packaged IC is typically in the tens of Gigabits/second.

Likewise, a computer or communication system “bus” is an interconnection allowing communication between plug-in modules. The plug in modules, typically printed circuit boards (PCBs), connect to the bus on a backplane printed circuit board. The data transfers are controlled according to a bus protocol. Plug in modules typically connect to the bus through edge connectors and drive the bus through high power bus transceivers. Various standards define the physical backplane PCB, the mechanical packaging, and the bus protocols. There are also a number of bus standards, including PCI, VME, FutureBus+, and Nubus standards.

In any event, and as will be readily appreciated by those skilled in the art, there are various problems which limit the bandwidth of bus communications. Capacitive loading on a bus due to the plurality of attached modules increases the propagation delay, which also impacts the data transfer rate. Capacitive loading also decreases the impedance of a bus line to a very low value, and results in high currents required to drive the bus at full speed. Improperly terminated bus lines result in multiple reflections of the transmitted signal. The reflections take one or more bus round trip delays to settle, resulting in a settling time delay that is a significant portion of the transfer cycle time for a bus. Finally, in addition to low bandwidths, electronic busses lack multiple independent channels and cannot provide the parallelism required by large scale parallel computing and communication systems. Nor are the busses scalable to interconnect hundreds of plug in modules since the increasing capacitance, inductance and impedance problems place a limit on the data transfer speed.

Having recognized that communication requirements between plug-in modules may soon exceed the capabilities of electrical wiring and conventional bus architectures, others have proposed the use of parallel fiber optic links between optoelectronic transceiver elements of respective circuit boards. An example of this approach is depicted in FIG. 1, wherein there is shown on a major surface 11 of each of first and second optically interconnected printed circuit boards (PCBs) 10a and 10b, a plurality of transmitter sections indicated generally at 12a and 12b and a plurality of receiver sections indicated generally at 14a and 14b. In each transmitter section as transmitter section 12a optically interconnected to receiver section 14a, there is a 1×N array of transmitter modules, e.g., a single row of vertical cavity semiconductor emitting lasers (VCSELs). Similarly, in each receiver section, there is a 1×N array of receiver modules, e.g., a single row of photodetectors adapted to convert respective received optical signals into corresponding received electrical signals for further processing by PCB 10a or 10b. The respective arrays constituting a pair of transmitter and receiver sections are optically interconnected by individual optical fiber links, typically using a bundle of fibers 15 in a ribbon configuration. Fiber connectors (not shown) associated with each end of each fiber bundle facilitate interconnections to a transmitter section and a receiver section. It will, of course be appreciated that although plug-in PCB modules having bi-directional communication is exemplified by FIG. 1, it is also known to employ unidirectional communication in which all transmitter sections are disposed on a first PCB and all receiver sections are disposed on a complementary second PCB.

In any event, and with continued reference to the exemplary prior art structure of FIG. 1, the fiber optic transceivers containing the electronic to optical conversion circuitry (and vice versa) are mounted at a peripheral edge of each printed circuit board. As will be readily ascertained by those skilled in the art, the dimensions of the transmitter or receiver sections as sections 12a and 14a generally exceed those of the fiber connectors, so that the approach exemplified by FIG. 1 wastes edge length compared to an approach in which the individual transmitter and receiver sections are located in the interior of the cards and jumpers are used to connect them to fiber connectors located on the edges. Thus, and as best seen in FIG. 2, a higher density of transceiver sections 12a, 12b is made possible by locating a plurality of fiber connectors 16 proximate the peripheral edge of each plug in module as PCBs 10a and 10b and employing a fiber bundle pigtail connection 18a from each transmitter section row of transmitter modules to a corresponding fiber connector 16 and also employing a fiber bundle pigtail connection 18b from each receiver section row of receiver modules to a corresponding fiber connector 16. It is the fiber connectors associated with each transceiver pair, then, which are optically interconnected by each fiber bundle 15. The approach of FIG. 2, while potentially achieving a higher density than that of FIG. 1, does so only at a substantial cost in terms of surface area on the major surfaces 11 of boards 10a and 10b. That is, two components per link are required on each board (transmitter or receiver and fiber connector).

Accordingly, while each of the approaches depicted in FIGS. 1 and 2 overcomes many of the limitations and disadvantages associated with the use of electronic interconnections between circuit boards, a need persists for a bundled fiber interconnection approach which efficiently uses both edge length and card area.

### SUMMARY OF THE INVENTION

The aforementioned needs are addressed, and an advance is made in the art, by a multiple channel transmission system which includes at least two plug in modules interconnected by a plurality of optical fiber bundles. For greater transceiver density and design flexibility, two dimensional transceiver arrays (e.g., N×M arrays of transmitters and/or receivers) are mounted on a major surface of each plug-in module. Optical fiber connectors are employed at a peripheral edge of each plug-in module, and optical fibers interconnecting the transceivers and corresponding edge mounted connectors on a plug-in module are bundled into two dimensional (N×M) arrays at the point where they are optically coupled to two dimensional transceiver arrays (e.g., N×M arrays of transmitters and/or receivers). The bundles exiting each transmitter array fan out or diverge, as 1×N fiber groups or single fiber ribbons, as they approach a corresponding group of edge mounted fiber connectors. Optical interconnections between plug-in modules are achieved by fiber connections between edge-mounted connectors.

In accordance with an illustrative embodiment, on a major surface of at least one of the plug-in modules—which plug-in module may comprise a printed circuit board having a plurality of electronic circuits for generating and/or processing electrical communication signals—one or more transmitter section(s) is/are disposed at locations spaced from a peripheral edge surface. Each transmitter section includes two or more rows of transmitter modules with each transmitter module being operative to convert a respective electrical signal into a corresponding optical signal. Associated with each transmitter section is a corresponding first plurality of fiber bundles dimensioned and arranged to transport the optical signals transmitted by the two or more rows toward a corresponding receiver section(s). An end of one of the first bundles is optically coupled to one row of transmitter modules and an end of another of the first bundles is optically coupled to another row of transmitter modules, such that at least these two bundles are stacked in planes substantially parallel to the major surface as they exit a corresponding transmitter section. Also associated with each transmitter section is a corresponding group of optical connectors disposed at spaced locations along the peripheral edge, the number of optical connectors in a group corresponding to the number of fiber bundles exiting a transmitter section and being optically coupled thereto.

On a major surface of at least one of the plug-in modules, one or more receiver section(s) is/are disposed at locations spaced from a peripheral edge surface. Each receiver section includes two or more two or more rows of receiver modules with each receiver module being operative to convert a respective optical signal into a corresponding electrical signal. Associated with each receiver section is a corresponding first plurality of fiber bundles dimensioned and arranged to receive optical signals from a transmitting section. An end of one of the first bundles is optically coupled to one row of receiver modules and an end of another of the first bundles is optically coupled to another row of receiver modules, such that at least these two bundles are stacked in planes substantially parallel to the major surface as the enter a corresponding receiver section. Also associated with each receiver section is a corresponding group of optical connectors disposed at spaced locations along the peripheral edge of the plug-in module, the number of optical connectors in a group corresponding to the number of fiber bundles entering transmitter section and being optically coupled thereto.

### BRIEF DESCRIPTION OF THE DRAWINGS

The features, benefits and advantages of the present invention may be better understood by reference to the detailed description which follows, taken in conjunction with the accompanying drawings, in which:

FIG. 1 is a plan view depicting a conventional approach for establishing optical interconnections between plug-in electronic circuit modules;

FIG. 2 is an elevation view depicting an alternative conventional approach for establishing optical interconnections between plug-in electronic circuit modules;

FIG. 3 is a perspective view depicting the construction and interconnection of plug-in modules including a two dimensional transceiver array in accordance with the teachings of the present invention;

FIG. 4 is an enlarged perspective view depicting an illustrative two dimensional transceiver array configuration which may be employed in order to achieve a compact, efficient structure according to the present invention;

FIG. 5A is an enlarged perspective view depicting an illustrative two dimensional transmitter array configuration which may be employed in order to achieve a compact, efficient structure according to the present invention;

FIG. 5B is an enlarged perspective view depicting an illustrative two dimensional receiver array configuration which may be employed, in conjunction with the exemplary two dimensional transmitter array of FIG. 5A; and

FIG. 6 is a graphical representation depicting the relationship between the card surface area required to implement optical interconnections between cards and the number of fiber ribbons bundled into the transceivers on those cards.

### DETAILED DESCRIPTION

To those skilled in the art, the invention admits of many variations. The following is a description of an exemplary embodiment, offered as illustrative of the invention but not restrictive of the scope of the invention. The invention is directed to enhancing the capability for arranging electronic and optoelectronic circuits on a plug-in circuit module, and will be discussed in terms of several scenarios that demonstrate the various embodiments of the invention.

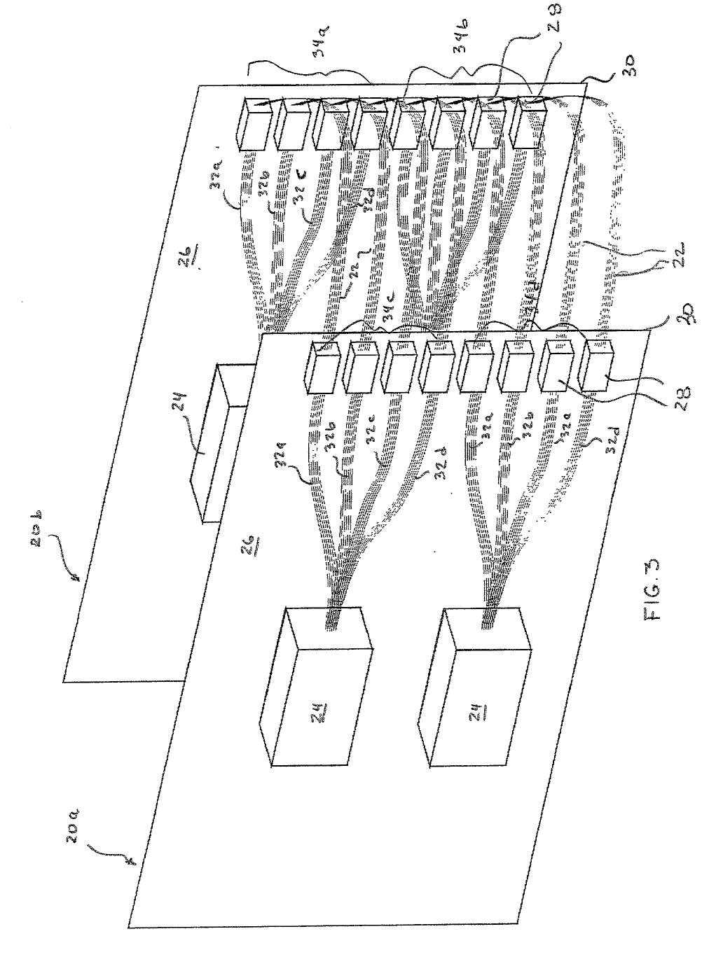

The present invention is made possible by a means of efficiently interconnecting optical fibers to emitters and detectors. By way of illustration, consider the greatly simplified, exemplary arrangement of optically interconnected first and second plug-in modules 20a and 20b depicted in FIG. 3, which constitute part of a multiple channel transmission system. As shown in FIG. 3, plug in modules 20a and 20, which are representative of many more interconnected plug-in modules (not shown), are optically interconnected by a plurality of optical fiber bundles 22. For greater transceiver density and design flexibility, two dimensional transceiver arrays 24 (e.g., N×M arrays of transmitters and/or receivers) are mounted on a major surface 26 of each plug-in module. Optical fiber connectors 28 are employed proximate a peripheral edge 30 of each plug-in module, and optical fibers interconnecting the transceiver arrays and corresponding edge mounted connectors 28 on a plug-in module are bundled into two dimensional (N×M) arrays at the point where they are optically coupled to two dimensional transceiver arrays (e.g., N×M arrays of transmitters and/or receivers). In the illustrative example shown in FIG. 3, the bundles of fibers 32a-32d exiting each transceiver array fan out or diverge, as four 1×N fiber groups which may be packages as optical fiber ribbons, as they approach a corresponding group 34a-34d of edge mounted fiber connectors 28. Optical interconnections 22 between plug-in modules are achieved, for example, by ribbon fiber bundles between edge-mounted connectors 28. Although the number of fibers in each 1×N row of the transceiver array is shown to be 6, it will be readily appreciated by those skilled in the art that any number of such fibers and corresponding transceiver elements maybe employed.

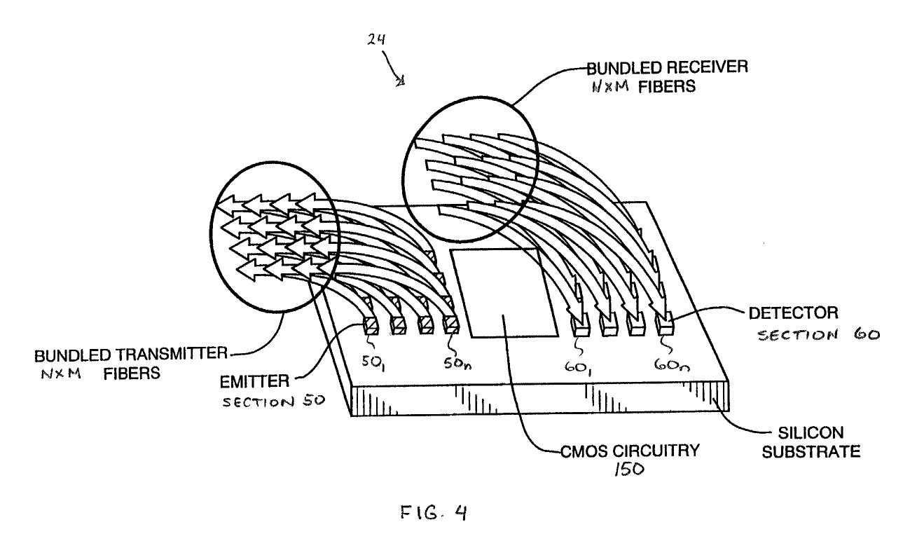

Turning now to FIG. 4, it will be seen that the transceiver array 24 may be arranged in a single horizontal plane for mounting on the major surface of a plug-in module (not shown). In the illustrated transceiver configuration shown in FIG. 4, transmitters 50 and receivers 60 are grouped together in respective N×M arrays, and there is on-chip circuitry 150. Such a structure may be especially advantageous when the amount of on-chip processing exceeds the area available for integrated circuitry, the 125 micron by 125 micron squared area per transmitter/detector. However, this approach is also a good strategy in some cases where the allowed circuitry is smaller than the 125 by 125 micron squared area. Encompassing on chip processing capability may have several advantages. The on chip circuitry provides greater flexibility for on-chip signal processing, e.g., error correction, protocol, flow control, etc. It also facilitates signal routing on and off the chip. For example, a ring topology would require two groups of bundles, and a star topology would require many more groups of bundles. Incorporating on chip processing capability may also aid in the fabrication of the device.

By bundling groups of fibers, one from transmitter section 50 and the one for receiver section 60, bi-directional data flow over individual fibers is achieved with fewer process steps. Bundling groups of fibers together also reduces the complexity of connecting multiple fibers from one node to another. Instead of connecting fibers one by one, they can be connected in groups, reducing the probability of misconnecting fibers. Each transmitter and receiver module as modules 62₁-62ₙ and 64₁ and 64_{w}, respectively, in a 1×N row has a pigtail fiber, with each 1×N grouping being ribbonized and having a multiple channel optical connector 28 (FIG. 3) fixed at one end thereof. Such an arrangement avoids the losses which would be associated by incorporating a second multiple channel connector at the interface with the receiver and transmitter modules. Optical connector 28 is fixed by the peripheral edge 30 of a board.

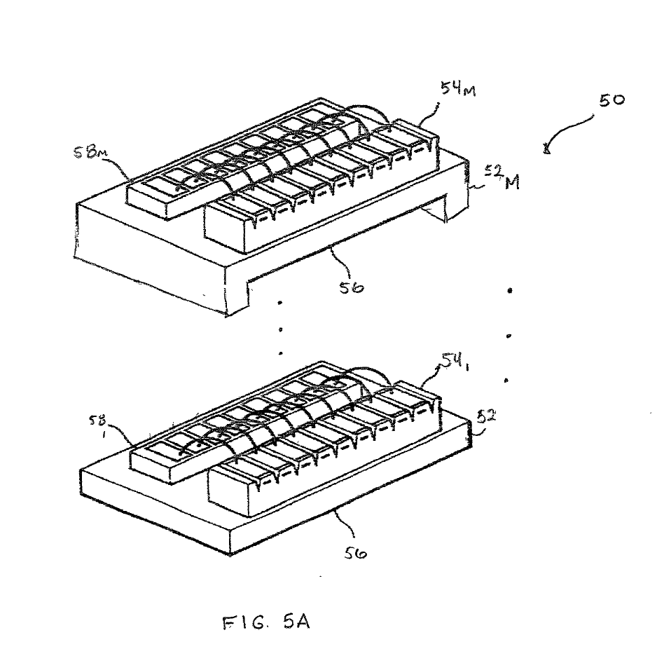

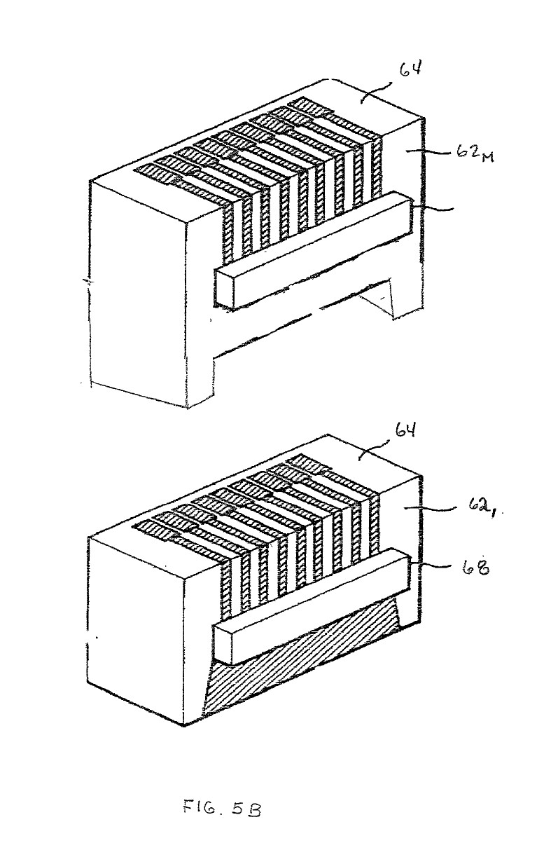

FIGS. 5A and 5B indicate the construction of separate transmitter and receiver N×M array structures in accordance with another embodiment of the present invention. For ease of illustration, only two layers are shown in FIGS. 5A and 5B. As seen in FIG. 5A, each transmitter section 50 may be arranged to form M stacks of 1×N transmitter arrays 52₁-52_{M} for a substantial improvement in space utilization of the major surface. Illustratively, each 1×N laser transmitter array, indicated generally as 54₁ to 54_{M}, is formed on a p type semiconductor substrate and this semiconductor substrate serves as a p side common terminal for all of the laser transmitter modules of that array. The lasers are mounted on a submount and control of characteristics thereof, etc. are effected in a conventional manner. FIG. 5A indicates each array as array 54₁ is secured to a metal block 56, to which a wiring board 58₁ to 58_{M} is soldered and every laser module is wirebonded with the wiring board. A metal package enclosing the optoelectronic transmitter structure (not shown) is designed to be at ground potential and provide an EMI shield. Accordingly, the p side common terminal of the lasers is preferably connected with the metal package with low parasitic elements through the submount metal block in order to reduce electric crosstalk in each laser array.

Each of the lasers has, for example, a multiple quantum well active layer structure; a short cavity of 150 micron; and a highly reflective end surface of 70%-90%. The interval between lasers is 250 microns and the threshold current is preferably smaller than 3 mA.

Likewise, as seen in FIG. 5B, the receiver section 60 may also be arranged as a two dimensional N×M array of receiver modules 62₁ through 62_{M}. Each 1×N array of receiver modules consists of a photodiode array 64 secured to a submount. Each receiver section also includes an IC substrate (not shown) on which a receiver IC (not shown) is mounted, with electrical signal outputs and pins for power power sypply. Essentially, each photodiode array is formed on an n-type conductivity substrate and this n-type conductivity substrate serves as an n side common terminal for all the photodiodes in an array. Like the laser array, each photodiode array is disposed in a metallic housing (not shown) to provide EMI shielding and reduce electric crosstalk. Wire bonds between each photodiode array and the receiver IC are performed in a conventional manner.

Because the stacked array implementation, as exemplified by FIGS. 5A and 5B results in the greatest savings of space on the major surface of each plug in board, it is especially preferred over the single plane structure of FIG. 4. In implementing such an architecture, it is recommended that the optoelectronic receiver and transmitter packages be provided with EMI shielding to protect adjacent electronic circuitry on the corresponding plug-in module. It is believed by the inventors herein that the fabrication of stacked transmitter and receiver modules as are contemplated by FIGS. 4, 5A and 5B are well understood and a detailed discussion of those fabrication steps has therefore been omitted for clarity. It suffices to say that by appropriate application of conventional photolithographic and wire bonding processes, the objectives of the present invention may be readily achieved by one skilled in the art.

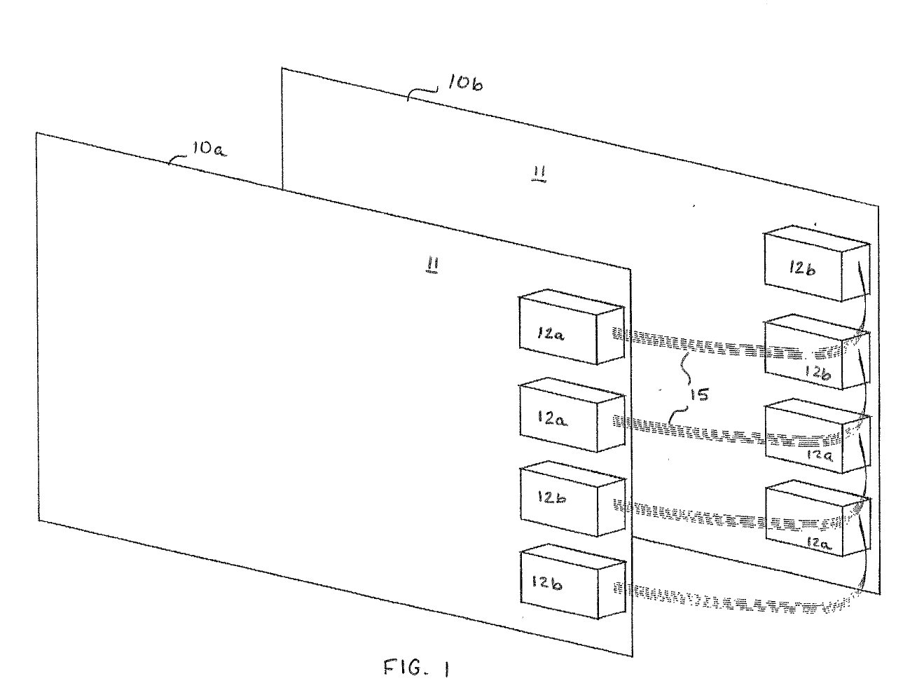

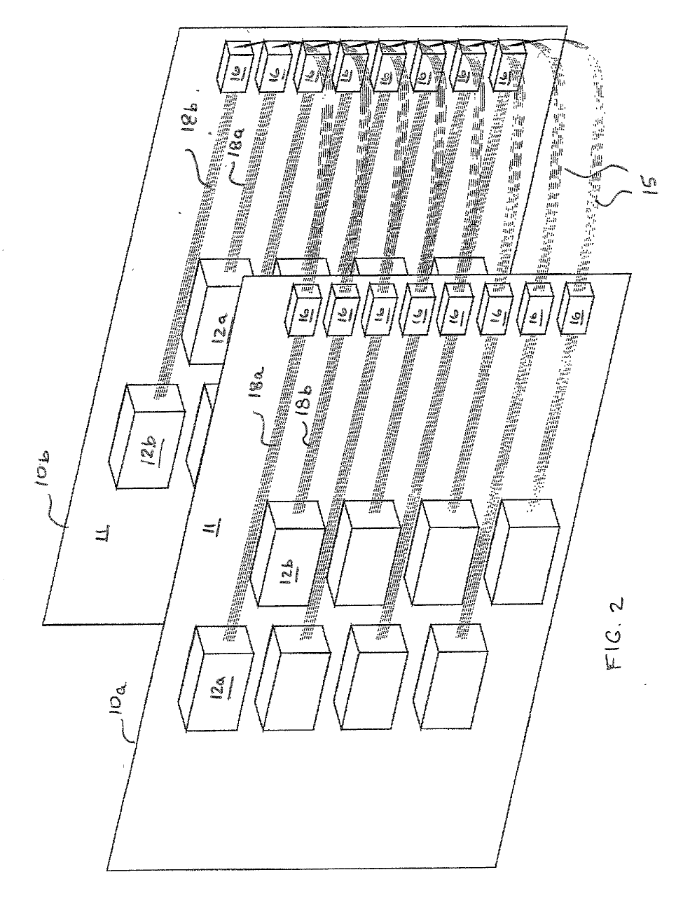

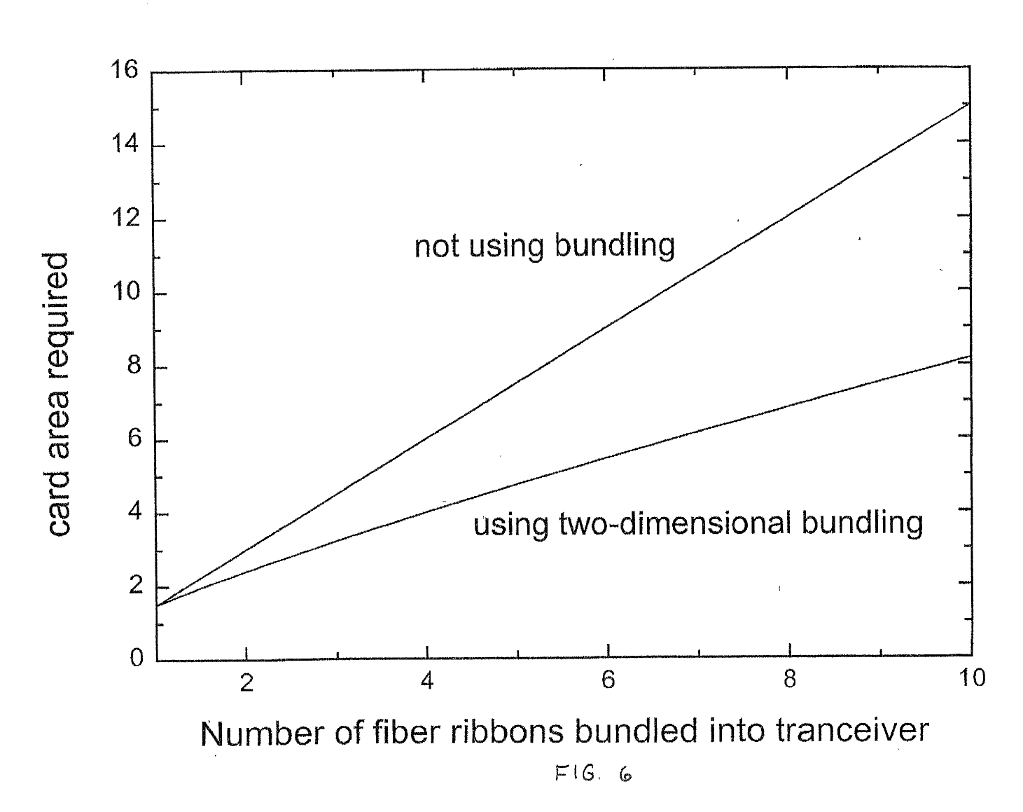

From the foregoing description, it will be appreciated that by bundling the fibers and transceiver modules into two dimensional arrays, the surface area of each plug-in module or circuit card is conserved. As compared to the prior art approaches depicted in FIGS. 1 and 2, the number of components per link is now (M+1)/M, where M is the number of ribbons that are bundled into a transceiver. Thus, the number of components per ribbon approaches one as the number of ribbons becomes large, compared to 2 for the solution of FIG. 2, thus greatly reducing component count. While it is true that two dimensional transceivers will generally be larger as M increases, the inventors herein have found that their area increases not linearly with M, but as M^{0.5}+M/2. The size of a transceiver for M=1 is generally twice the size of the fiber connector. Thus, while the card area requirements per ribbon may be represented as M^{0.5}+M/2, as noted above, the care area requirements for the approach of FIG. 2 is represented as M+M/2. As such, and by way of illustrative example, for a bundle count of M=4, a 33% area savings by applying the teachings of the present invention. The relationship between the card area required and the number of fiber ribbons bundled into the transceivers is graphically illustrated in FIG. 6.

While the above described embodiments of the invention are preferred, other configurations will be readily apparent to those skilled in the art, and thus the invention is only to be limited in scope by the language of the following claims and equivalents.

What is claimed is:

1. A multiple channel transmission system, comprising:
a first plug in module having
an edge surface and having disposed on a major surface thereof, spaced away from said edge surface, a transmitter section including an array of transmitter modules each operative to convert a respective electrical signal into a corresponding optical signal;
a first plurality of bundles of optical waveguides dimensioned and arranged to transmit the optical signals, a first end of a first of said first plurality of bundles being optically coupled to a first group of said transmitter modules and a first end of a second of said first plurality of bundles being optically coupled to a second group of said transmitter modules, said first plurality of bundles being stacked in planes substantially parallel to said major surface to form a two dimensional array at a location proximate each first end; and
a first plurality of multi-channel optical connectors disposed at spaced locations along said edge, a first optical connector being optically coupled to a second end of the first of said bundles and a second optical connector being optically coupled to a second end of the second of said bundles;
a second plug in module having
a second edge surface and having disposed on a major surface thereof, spaced away from said second edge surface, a receiver section including an array of receiver modules each operative to convert a respective optical signal into a corresponding electrical signal;
a second plurality of bundles of optical waveguides dimensioned and arranged to receive optical signals to be converted, a first end of a first of said second plurality of bundles being optically coupled to a first group of said receiver modules and a first end of a second of said second plurality of bundles being optically coupled to a second group of said receiver modules, said second plurality of bundles being stacked in planes substantially parallel to the major surface of the second plug in module to form a two dimensional array at a location proximate each second plug-in module first end; and
a second plurality of multi-channel optical connectors disposed at spaced locations along said second edge, a first optical connector of the second plurality of optical connectors being optically coupled to a bundle of said second plurality of bundles and a second optical connector being optically coupled to another bundle of said second plurality of bundles.

2. The transmission system of claim 1, wherein the transmitter modules are arranged in an N×M two dimensional array, and wherein said first plurality of fiber bundles comprises N fibers arranged in M bundles.

3. The transmission system of claim 1, wherein the receiver modules are arranged in an N×M two dimensional array, and wherein said second plurality of fiber bundles comprises N fibers arranged in M bundles.

4. The transmission system of claim 1, wherein said first plug in module further includes a first plug-in module receiver section including an array of receiver modules each operative to convert a respective optical signal into a corresponding electrical signal;
a third plurality of bundles of optical waveguides dimensioned and arranged to receive optical signals to be converted from a remote plug-in module, a first end of a first of said third plurality of bundles being optically coupled to a first group of said first plug-in module receiver modules and a first end of a second of said third plurality of bundles being optically coupled to a second group of said first plug-in module receiver modules, said third plurality of bundles being stacked in planes substantially parallel to the major surface of the first plug in module to form a two dimensional array; and
a third plurality of multi-channel optical connectors disposed at spaced locations along the edge of the first plug in module, a first optical connector of the third plurality of optical connectors being optically coupled to a bundle of said third plurality of bundles and a second optical connector of the third plurality being optically coupled to another bundle of said third plurality of bundles.

5. The transmission system of claim 1, wherein the plurality of transmitter modules are fixed in one body.

6. The transmission system of claim 5, wherein the plurality of transmitter modules are arranged in a two-dimensional N×M stack.

7. The transmission system of claim 1, wherein the plurality of receiver modules are fixed in one body.

8. The transmission system of claim 7, wherein the plurality of receiver modules are arranged in a two dimensional N×M stack.

9. The transmission system of claim 4, wherein at least one group of the third plurality of receiver modules and at least one group of the first plurality of transmitter modules are fixed in one body.

10. The transmission system of claim 1, further including optical fiber links for interconnecting at least some of said first plurality of optical connectors to at least some of said second plurality of connectors.

11. A plug-in module for use in a communication system, comprising:
a transmitter section including an array of transmitter modules each operative to convert a respective electrical signal into a corresponding optical signal, said transmitter modules being disposed on a major surface of said plug in module and being spaced from a peripheral edge thereof;
a plurality of bundles of optical waveguides dimensioned and arranged to transmit the optical signals, a first end of a first bundle being optically coupled to a first group of said transmitter modules and a first end of a second bundle being optically coupled to a second group of said transmitter modules, said bundles being arranged in a stacked two dimensional array in planes substantially parallel to said major surface; and
a plurality of optical connectors disposed at spaced locations along said peripheral edge, a first optical connector being optically coupled to a second end of the first of said bundles and a second optical connector being optically coupled to a second end of the second of said bundles, whereby said bundles diverge from a stacked arrangement proximate the transmitter section in a direction toward said peripheral edge.

12. The transmission system of claim 11, wherein the transmitter modules are arranged in an N×M two dimensional array, and wherein the fiber bundles comprises N fibers arranged in M bundles proximate the transmitter section.

13. A plug-in module for use in a communication system, comprising:
a receiver section including an array of receiver modules each operative to convert a respective optical signal into a corresponding electrical signal, said receiver modules being disposed on a major surface of said plug in module and being spaced from a peripheral edge thereof;
a plurality of bundles of optical waveguides dimensioned and arranged to receive the optical signals, a first end of a first bundle being optically coupled to a first group of said receiver modules and a first end of a second bundle being optically coupled to a second group of said receiver modules, said bundles being arranged in a stacked two dimensional array in planes substantially parallel to said major surface; and
a plurality of optical connectors disposed at spaced locations along said peripheral edge, a first optical connector being optically coupled to a second end of the first of said bundles and a second optical connector being optically coupled to a second end of the second of said bundles, whereby said bundles diverge from a stacked arrangement proximate the receiver section in a direction toward said peripheral edge.

14. The transmission system of claim 11, wherein the transmitter modules are arranged in an N×M two dimensional array, and wherein the fiber bundles comprises N fibers arranged in M bundles proximate the transmitter section.
